(19) United States
(12) Patent Application Publication
(10) Pub. No.: US 2020/0173572 A1
(43) Pub. Date: Jun. 4, 2020

(54) UNIQUE BRACKET COUPLING FOR ROTARY VALVE

(71) Applicant: Johnson Controls Technology Company, Auburn Hills, MI (US)

(72) Inventors: Amol Ramdas Vetal, Pune (IN); Yogesh Subhash Chorghe, Pune (IN); Anil Kumar, Agra (IN)

(73) Assignee: Johnson Controls Technology Company, Auburn Hills, MI (US)

(21) Appl. No.: 16/206,468

(22) Filed: Nov. 30, 2018

(51) Int. Cl. F16K 27/08; F16K 35/02

(52) U.S. Cl. CPC F16K 27/08; F16K 31/00; F16K 35/027

(57) ABSTRACT

One implementation of the present disclosure is an actuator mounting assembly. The actuator mounting assembly includes a bracket and a coupling member. The bracket defining a central opening extending therethrough. The bracket includes an actuator end and a valve end. The actuator end includes an actuator interface member. The valve end includes a plurality of legs extending away from the actuator end. The coupling member is at least partially disposed within the central opening. The coupling member includes a valve stem end configured to engage a valve stem and a driver end configured to engage an actuator drive member.

### BACKGROUND

The present disclosure relates generally to linkage systems for actuators. Actuators are mechanical devices configured to operate or actuate a wide variety of equipment. For example, actuators can be used to actuate a damper, a valve, a mechanical linkage or assembly, or any other type of mechanism or system. The actuators may be used in a heating, ventilating, or air conditioning (HVAC) system and more particularly to assembly of an enclosure for an HVAC actuator. For example, an actuator may be coupled to a damper in an HVAC system and may be used to drive the damper between an open position and a closed position.

In other implementations, actuators are generally electrical, hydraulic, or pneumatic devices that actuate a variety of equipment by moving a movable part of that equipment between two or more positions. For example, actuators can be used to actuate a damper, a valve, a mechanical linkage or assembly, or any other type of mechanism or system. An actuator may transfer a rotation or other force to the mechanism, such as a valve, through a final output gear. When the valve is properly engaged with the actuator, a rotation created by the actuator can cause a rotation of the valve between two positions, for example an open position and a closed position. The linkage system between the actuator and valve can include the output gear, a yoke or adaptor, and a stroke, spacer, bracket, or other connector. As will be appreciated, the valve and adaptor must have complementary mating features (e.g., linkage system) in order to properly function.

### SUMMARY

One implementation of the present disclosure is an actuator mounting assembly. The actuator mounting assembly includes a bracket and a coupling member. The bracket defining a central opening extending therethrough. The bracket includes an actuator end and a valve end. The actuator end includes an actuator interface member. The valve end includes a plurality of legs extending away from the actuator end. The coupling member is at least partially disposed within the central opening. The coupling member includes a valve stem end configured to engage a valve stem and a driver end configured to engage an actuator drive member.

In some embodiments, the plurality of legs includes a first leg and a second leg disposed outermost and adjacent to an edge of the middle portion. The first leg and the second leg each are configured to engage a mounting hole formed by a valve body. A plurality of support legs is disposed between the first leg and the second leg. The plurality of support legs are configured to engage a mounting pad on the valve body. A plurality of snap-fit legs is disposed inside of the plurality of support legs and outside the central opening. The plurality of snap-fit legs is configured to engage the valve in a snap-fit engagement.

In some embodiments, each snap-fit leg of the plurality of snap-fit legs comprises a radially flexible leg and a snap member to engage a portion of the valve body.

In some embodiments, the rotation of the driver causes the driver end to rotate and the valve stem end to rotate, thereby rotating the valve stem knob.

In some embodiments, the snap member is a hooked member that protrudes radially inward toward the central opening, the hooked member configured to securely engage a snap surface on the valve stem.

In some embodiments, the mounting hole comprises a first mounting hole and a second mounting hole, wherein the first leg and the second leg are disposed on opposite ends of the middle portion, the first leg comprising a first groove that is formed axially therealong and the second leg comprising a second groove that is formed axially therealong, the first groove and the second groove configured to orient the bracket in a desired orientation when the first leg is disposed within the first mounting hole and the second leg is disposed within the second mounting hole.

In some embodiments, a plurality of support legs disposed between the first leg and the second leg, the plurality of support legs configured to engage a mounting pad on the valve body and to restrict rotary motion of an actuator that includes the actuator drive member.

In some embodiments, the actuator interface member axially protrudes from the middle portion away from the valve end, the actuator interface member comprising a slot and the central opening extending therethrough, the slot extend around an external surface of the actuator interface member, the slot configured to receive a locking surface of an actuator that comprises the actuator drive member.

In some embodiments, the valve stem end is disposed substantially within the central opening of the bracket, and wherein the driver end is disposed substantially outside of the central opening of the bracket.

In some embodiments, the valve stem end comprises a coupling groove configured to receive the valve stem and the driver end include a coupling protruding member configured to be inserted into the actuator drive member.

In some embodiments, the coupling groove comprises a groove that is formed by two mirrored parallel surfaces and two mirrored rounded surfaces, wherein the protruding member comprises a protrusion being formed by similar mirrored parallel surfaces and two mirrored rounded surfaces.

In some embodiments, the rotation of the actuator drive member causes the driver end to rotate and the valve stem end to rotate, thereby rotating the valve stem.

Another implementation of the present disclosure is a valve assembly. The valve assembly includes an actuator, a valve, and an actuator mounting assembly. The actuator includes an actuator drive member. The valve includes a valve stem. The actuator mounting assembly includes a bracket and a coupling member. The bracket defining a central opening extending therethrough. The bracket includes an actuator end and a valve end. The actuator end includes an actuator interface member. The valve end includes a plurality of legs extending away from the actuator end. The coupling member is at least partially disposed within the central opening. The coupling member includes a valve stem end configured to engage a valve stem and a driver end configured to engage an actuator drive member.

In some embodiments, the valve body comprises a first mounting hole and a second mounting hole formed by a valve body, and wherein the plurality of legs comprises a first leg and a second leg disposed outermost and adjacent to an edge of the middle portion, the first leg configured to engage the first mounting hole formed by the valve body, and the second leg configured to engage the second mounting hole formed by the valve body and a plurality of snap-fit legs disposed inside of the first leg and the second leg and outside the central opening, the plurality of snap-fit legs configured to engage the valve body in a snap-fit engagement.

In some embodiments, each snap-fit leg of the plurality of snap-fit legs comprises a radially flexible leg and a snap member to engage a portion of the valve body, the snap member is a hooked member that protrudes radially inward toward the central opening, the hooked member configured to securely engage a snap surface on the valve stem.

In some embodiments, the first leg and the second leg are disposed on opposite ends of the middle portion, the first leg comprising a first groove that is formed axially therealong and the second leg comprising a second groove that is formed axially therealong, the first groove and the second groove configured to orient the bracket in a desired orientation when the first leg is disposed within the first mounting hole and the second leg is disposed within the second mounting hole.

In some embodiments, the valve body further comprises a mounting pad surrounding the valve stem, and wherein the plurality of legs further comprises a plurality of support legs disposed between the first leg and the second leg, the plurality of support legs configured to engage a mounting pad on the valve body and to restrict rotary motion of the actuator.

In some embodiments, the actuator interface member axially protrudes from the middle portion away from the valve end, the actuator interface member comprising a slot and the central opening extending therethrough, the slot extend around an external surface of the actuator interface member, the slot configured to receive a locking surface of the actuator.

In some embodiments, the valve stem end comprises a coupling groove configured to receive the valve stem and the driver end include a coupling protruding member configured to be inserted into the actuator drive member, and wherein the valve stem end is disposed substantially within the central opening of the bracket, and wherein the driver end is disposed substantially outside of the central opening of the bracket.

Another implementation of the present disclosure includes a method of assembling a valve assembly. The method includes inserting a coupling member within a central opening of a bracket to form an actuator mounting assembly. The bracket defines a central opening therethrough and the bracket comprising an actuator end and a valve end, the actuator end comprising an actuator interface member and the valve end comprising a plurality of legs extending away from the actuator end. The coupling member includes a valve stem end configured to engage a valve stem and a driver end configured to engage an actuator drive member. The coupling member is inserted within the bracket such that the valve stem end is at least partially disposed within the central opening and the driver end is at least partially disposed outside of the central opening. The actuator mounting assembly engages with a valve body. The engagement includes inserting a valve stem of the valve body into a groove formed in the valve stem end and coupling the plurality of legs with the valve body. The actuator end of the bracket engages with an actuator. The engagement causes the driver end of the coupling member to be inserted within the actuator drive member of the actuator.

In some embodiments, a first leg and a second leg disposed outermost and adjacent to an edge of the valve end, the first leg configured to engage a first mounting hole formed by a valve body and the second leg configured to engage a second mounting hole formed by a valve body. A plurality of snap-fit legs are disposed inside of the plurality of support legs and outside the central opening, wherein each snap-fit leg of the plurality of snap-fit legs comprises a radially flexible leg and a snap member to engage a portion of the valve body, the snap member protrudes radially inward toward the central opening. The actuator mounting assembly engages with the valve body further including inserting the first leg into the first mounting hole and the second leg into the second mounting hole and pressing the actuator mounting assembly downward to cause the snap member of each snap-fit leg in the plurality of snap-fit legs to securely engage a snap surface on the valve stem.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

FIG. 1 is a drawing of a building equipped with a heating, ventilating, or air conditioning (HVAC) system and a building management system (BMS), according to an exemplary embodiment.

FIG. 2 is a schematic diagram of a waterside system which may be used to support the HVAC system of FIG. 1, according to an exemplary embodiment.

FIG. 3 is a block diagram of an airside system which may be used as part of the HVAC system of FIG. 1, according to an exemplary embodiment.

FIG. 4 is a block diagram of a BMS which may be implemented in the building of FIG. 1, according to an exemplary embodiment.

FIG. 5 is a perspective view of an unassembled actuator and rotary valve with an adaptor, according to an exemplary embodiment.

FIG. 6A is a bottom perspective view of a coupling member of the adaptor of FIG. 5, according to an exemplary embodiment.

FIG. 6B is a side view of the coupling member of the adaptor of FIG. 6A, according to an exemplary embodiment.

FIG. 6C is a top view of the coupling member of the adaptor of FIG. 6A, according to an exemplary embodiment.

FIG. 7A is a bottom perspective view of a bracket of the adaptor of FIG. 5, according to an exemplary embodiment.

FIG. 7B is a side view of the bracket of the adaptor of FIG. 7A, according to an exemplary embodiment.

FIG. 7C is a bottom view of the bracket of the adaptor of FIG. 7A, according to an exemplary embodiment.

FIG. 7D is a top perspective view of the bracket of the adaptor of FIG. 7A, according to an exemplary embodiment.

FIG. 7E is a top view of the bracket of the adaptor of FIG. 7A, according to an exemplary embodiment.

FIG. 8 is a perspective view of a rotary valve and an adaptor, according to an exemplary embodiment.

FIG. 9 is a perspective view of a rotary valve and an adaptor, according to another exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the FIGURES, an actuator is shown, according to an exemplary embodiment. The actuator may be an HVAC actuator, such as a damper actuator, a valve actuator, a fan actuator, a pump actuator, or any other type of actuator that can be used in an HVAC or other system.

The aspects described herein may, increase interoperability and use of actuator and valve systems by allowing for configurations that implement a wide variety of actuators and valves and do not require special tooling of the actuator and/or the valve. Beneficially, the adaptor described herein that includes a unique bracket and coupling member design, allows for a wide variety of valves with distinct mounting surfaces to interface with and engage actuators with a wide range of distinct mounting surfaces. The adaptor is specifically tailored to provide easy interface with a valve and actuator, while providing a robust engagement that sustains the actuator load and restricting rotary and linear motion of the actuator (depending on the type of valve). The adaptor allows for linear and rotary valves to be retrofit with actuators that have a wide variety of mounting surfaces (e.g., groove, angled, etc.) and mounting members (e.g., protrusions, pins, etc.).

The actuator mounting assembly includes a bracket and a coupling member. The bracket includes an actuator end, a middle portion, and a valve end, the middle portion disposed between the actuator end and the valve end. The actuator end includes an actuator interface portion. The actuator interface portion extends from the middle portion away from the valve end. The valve end includes a plurality of legs extending from the middle portion away from the actuator end. A central opening is formed in the bracket and extends therethrough. A coupling member includes a valve stem end and a driver end. The valve stem end is disposed within the central opening of the bracket. The driver end includes an elongated shape and the valve stem end including a groove.

### Building Management System and HVAC System

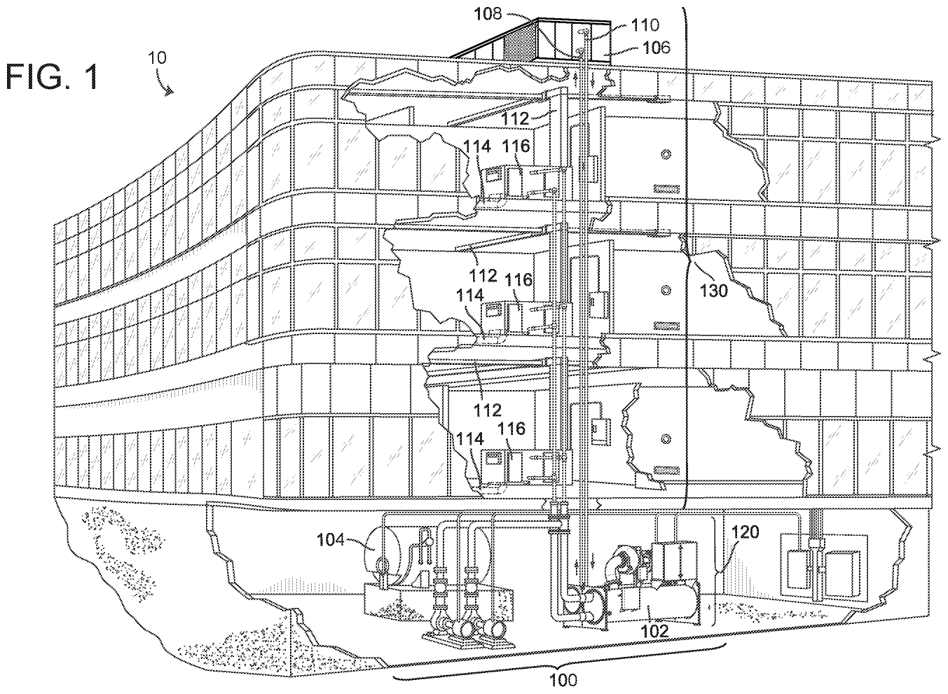

Referring now to FIGS. 1-4, an exemplary building management system (BMS) and HVAC system in which the systems and methods of the present disclosure may be implemented are shown, according to an exemplary embodiment. Referring particularly to FIG. 1, a perspective view of a building 10 is shown. Building 10 is served by a BMS. A BMS is, in general, a system of devices configured to control, monitor, and manage equipment in or around a building or building area. A BMS may include, for example, an HVAC system, a security system, a lighting system, a fire alerting system, and any other system that is capable of managing building functions or devices, or any combination thereof

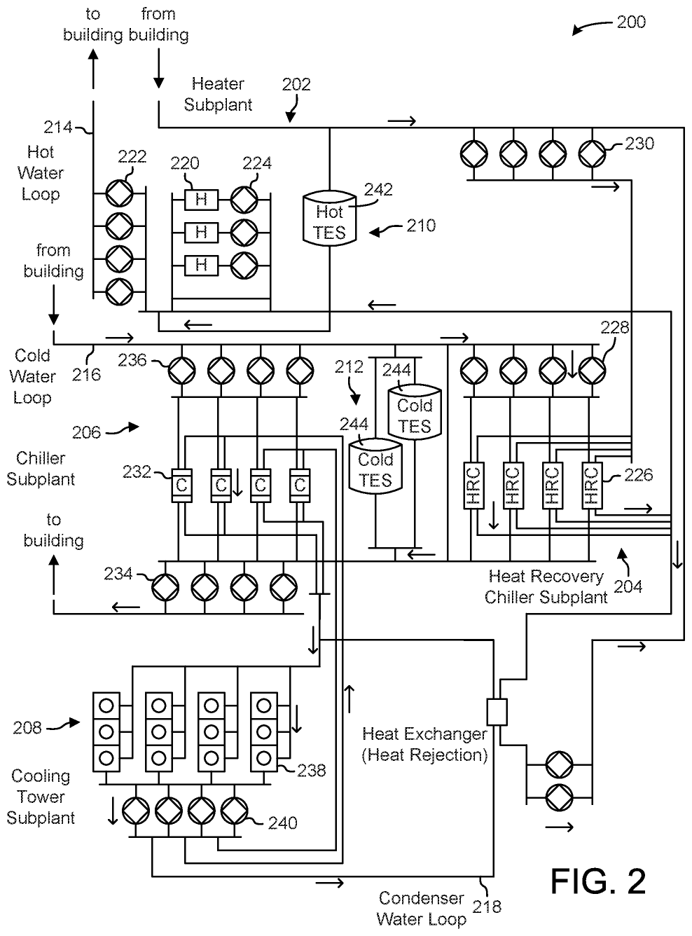

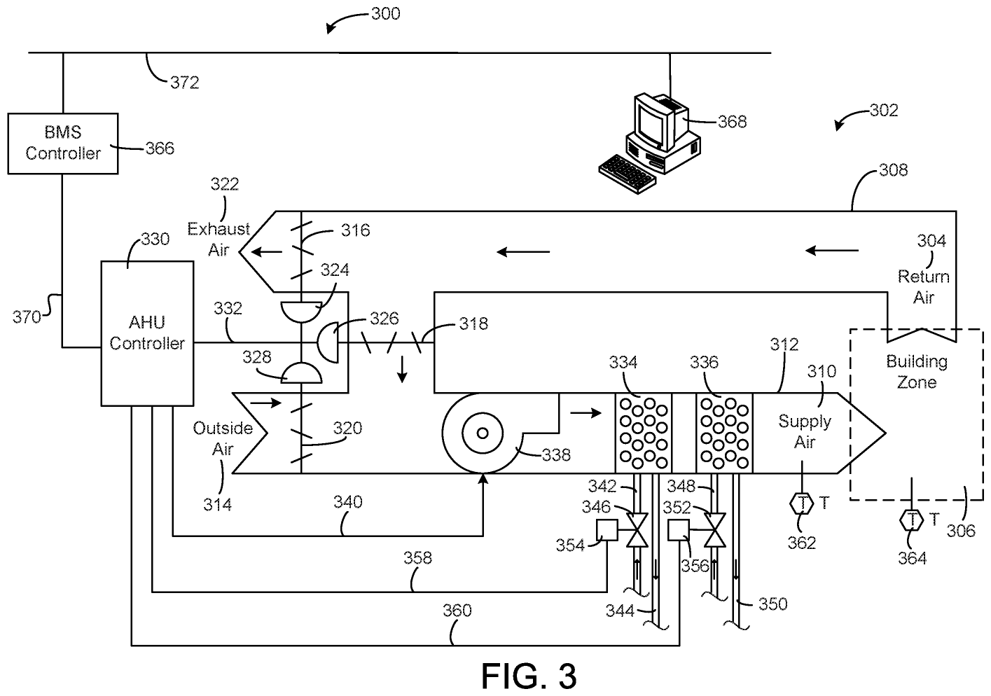

The BMS that serves building 10 includes an HVAC system 100. HVAC system 100 may include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 may provide heated or chilled fluid to an air handling unit of airside system 130. Airside system 130 may use the heated or chilled fluid to heat or cool an airflow provided to building 10. An exemplary waterside system and airside system which may be used in HVAC system 100 are described in greater detail with reference to FIGS. 2-3.

HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 may be located in or around building 10 (as shown in FIG. 1) or at an offsite location such as a central plant (e.g., a chiller plant, a steam plant, a heat plant, etc.). The working fluid may be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 may be transported to AHU 106 via piping 108.

AHU 106 may place the working fluid in a heat exchange relationship with an airflow passing through AHU 106 (e.g., via one or more stages of cooling coils and/or heating coils). The airflow may be, for example, outside air, return air from within building 10, or a combination of both. AHU 106 may transfer heat between the airflow and the working fluid to provide heating or cooling for the airflow. For example, AHU 106 may include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (i.e., the supply airflow) to building 10 via air supply ducts 112 and may provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 may include dampers or other flow control elements that may be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 may include various sensors (e.g., temperature sensors, pressure sensors, etc.) configured to measure attributes of the supply airflow. AHU 106 may receive input from sensors located within AHU 106 and/or within the building zone and may adjust the flow rate, temperature, or other attributes of the supply airflow through AHU 106 to achieve set point conditions for the building zone.

Referring now to FIG. 2, a block diagram of a waterside system 200 is shown, according to an exemplary embodiment. In various embodiments, waterside system 200 may supplement or replace waterside system 120 in HVAC system 100 or may be implemented separate from HVAC system 100. When implemented in HVAC system 100, waterside system 200 may include a subset of the HVAC devices in HVAC system 100 (e.g., boiler 104, chiller 102, pumps, valves, etc.) and may operate to supply a heated or chilled fluid to AHU 106. The HVAC devices of waterside system 200 may be located within building 10 (e.g., as components of waterside system 120) or at an offsite location such as a central plant.

In FIG. 2, waterside system 200 is shown as a central plant having a plurality of subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve the thermal energy loads (e.g., hot water, cold water, heating, cooling, etc.) of a building or campus. For example, heater subplant 202 may be configured to heat water in a hot water loop 214 that circulates the hot water between heater subplant 202 and building 10. Chiller subplant 206 may be configured to chill water in a cold water loop 216 that circulates the cold water between chiller subplant 206 and building 10. Heat recovery chiller subplant 204 may be configured to transfer heat from cold water loop 216 to hot water loop 214 to provide additional heating for the hot water and additional cooling for the cold water. Condenser water loop 218 may absorb heat from the cold water in chiller subplant 206 and reject the absorbed heat in cooling tower subplant 208 or transfer the absorbed heat to hot water loop 214. Hot TES subplant 210 and cold TES subplant 212 may store hot and cold thermal energy, respectively, for subsequent use.

Hot water loop 214 and cold water loop 216 may deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air may be delivered to individual zones of building 10 to serve the thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO2, etc.) may be used in place of or in addition to water to serve the thermal energy loads. In other embodiments, subplants 202-212 may provide heating and/or cooling directly to the building or campus without requiring an intermediate heat transfer fluid. These and other variations to waterside system 200 are within the teachings of the present disclosure.

Each of subplants 202-212 may include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 may also include one or more pumps or valves configured to control the flow rate of the hot water into or out of hot TES tank 242. Cold TES subplant 212 is shown to include cold TES tanks 244 configured to store the cold water for later use. Cold TES subplant 212 may also include one or more pumps or valves configured to control the flow rate of the cold water into or out of cold TES tanks 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves may be integrated with the pumps or positioned upstream or downstream of the pumps to control the fluid flows in waterside system 200. In various embodiments, waterside system 200 may include more, fewer, or different types of devices and/or subplants based on the particular configuration of waterside system 200 and the types of loads served by waterside system 200.

Referring now to FIG. 3, a block diagram of an airside system 300 is shown, according to an exemplary embodiment. In various embodiments, airside system 300 may supplement or replace airside system 130 in HVAC system 100 or may be implemented separate from HVAC system 100. When implemented in HVAC system 100, airside system 300 may include a subset of the HVAC devices in HVAC system 100 (e.g., AHU 106, VAV units 116, ducts 112-114, fans, dampers, etc.) and may be located in or around building 10. Airside system 300 may operate to heat or cool an airflow provided to building 10 using a heated or chilled fluid provided by waterside system 200.

In FIG. 3, airside system 300 is shown to include an economizer-type AHU 302. Economizer-type AHUs vary the amount of outside air and return air used by the air handling unit for heating or cooling. For example, AHU 302 may receive return air 304 from building zone 306 via return air duct 308 and may deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 may be configured to operate exhaust air damper 316, mixing damper 318, and outside air damper 320 to control an amount of outside air 314 and return air 304 that combine to form supply air 310. Any return air 304 that does not pass through mixing damper 318 may be exhausted from AHU 302 through exhaust damper 316 as exhaust air 322.

Each of dampers 316-320 may be operated by an actuator. For example, exhaust air damper 316 may be operated by actuator 324, mixing damper 318 may be operated by actuator 326, and outside air damper 320 may be operated by actuator 328. Actuators 324-328 may communicate with an AHU controller 330 via a communications link 332. Actuators 324-328 may receive control signals from AHU controller 330 and may provide feedback signals to AHU controller 330. Feedback signals may include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that may be collected, stored, or used by actuators 324-328. AHU controller 330 may be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 may be configured to force supply air 310 through cooling coil 334 and/or heating coil 336 and provide supply air 310 to building zone 306. AHU controller 330 may communicate with fan 338 via communications link 340 to control a flow rate of supply air 310. In some embodiments, AHU controller 330 controls an amount of heating or cooling applied to supply air 310 by modulating a speed of fan 338.

Cooling coil 334 may receive a chilled fluid from waterside system 200 (e.g., from cold water loop 216) via piping 342 and may return the chilled fluid to waterside system 200 via piping 344. Valve 346 may be positioned along piping 342 or piping 344 to control a flow rate of the chilled fluid through cooling coil 334. In some embodiments, cooling coil 334 includes multiple stages of cooling coils that may be independently activated and deactivated (e.g., by AHU controller 330, by BMS controller 366, etc.) to modulate an amount of cooling applied to supply air 310.

Heating coil 336 may receive a heated fluid from waterside system 200 (e.g., from hot water loop 214) via piping 348 and may return the heated fluid to waterside system 200 via piping 350. Valve 352 may be positioned along piping 348 or piping 350 to control a flow rate of the heated fluid through heating coil 336. In some embodiments, heating coil 336 includes multiple stages of heating coils that may be independently activated and deactivated (e.g., by AHU controller 330, by BMS controller 366, etc.) to modulate an amount of heating applied to supply air 310.

Each of valves 346 and 352 may be controlled by an actuator. For example, valve 346 may be controlled by actuator 354 and valve 352 may be controlled by actuator 356. Actuators 354-356 may communicate with AHU controller 330 via communications links 358-360. Actuators 354-356 may receive control signals from AHU controller 330 and may provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 may also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU controller 330 may control the temperature of supply air 310 and/or building zone 306 by activating or deactivating coils 334-336, adjusting a speed of fan 338, or a combination of both.

Still referring to FIG. 3, airside system 300 is shown to include a BMS controller 366 and a client device 368. BMS controller 366 may include one or more computer systems (e.g., servers, supervisory controllers, subsystem controllers, etc.) that serve as system-level controllers, application or data servers, head nodes, or master controllers for airside system 300, waterside system 200, HVAC system 100, and/or other controllable systems that serve building 10. BMS controller 366 may communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BMS controller 366 may be separate (as shown in FIG. 3) or integrated. In an integrated implementation, AHU controller 330 may be a software module configured for execution by a processor of BMS controller 366.

In some embodiments, AHU controller 330 receives information from BMS controller 366 (e.g., commands, setpoints, operating boundaries, etc.) and provides information to BMS controller 366 (e.g., temperature measurements, valve or actuator positions, operating statuses, diagnostics, etc.). For example, AHU controller 330 may provide BMS controller 366 with temperature measurements from temperature sensors 362-364, equipment on/off states, equipment operating capacities, and/or any other information that may be used by BMS controller 366 to monitor or control a variable state or condition within building zone 306.

Client device 368 may include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 may be a computer workstation, a client terminal, a remote or local interface, or any other type of user interface device. Client device 368 may be a stationary terminal or a mobile device. For example, client device 368 may be a desktop computer, a computer server with a user interface, a laptop computer, a tablet, a smartphone, a PDA, or any other type of mobile or non-mobile device. Client device 368 may communicate with BMS controller 366 and/or AHU controller 330 via communications link 372.

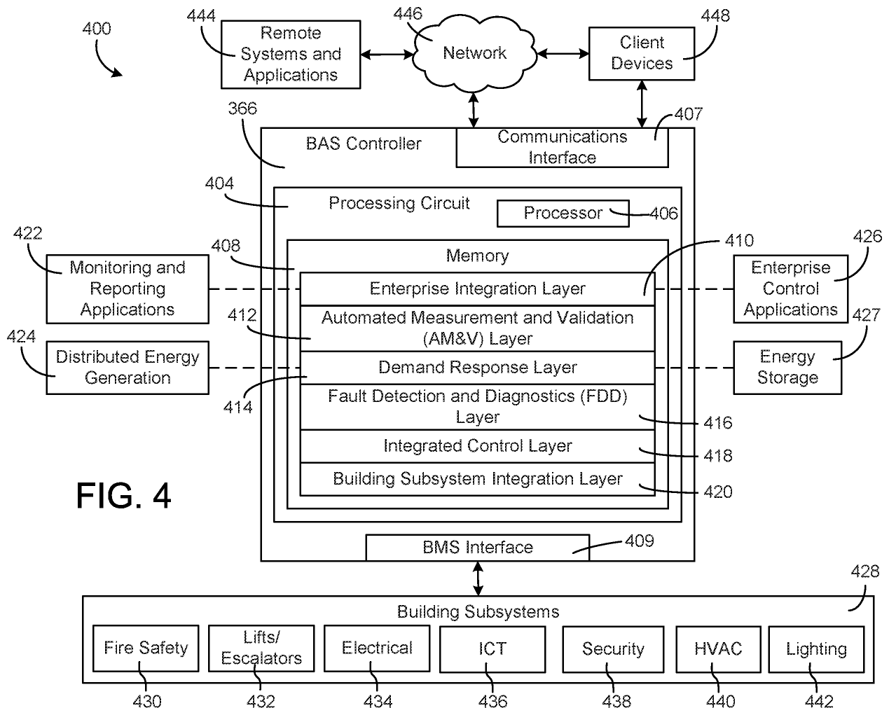

Referring now to FIG. 4, a block diagram of a BMS 400 is shown, according to an exemplary embodiment. BMS 400 may be implemented in building 10 to automatically monitor and control various building functions. BMS 400 is shown to include BMS controller 366 and a plurality of building subsystems 428. Building subsystems 428 are shown to include a building electrical subsystem 434, an information communication technology (ICT) subsystem 436, a security subsystem 438, an HVAC subsystem 440, a lighting subsystem 442, a lift/escalators subsystem 432, and a fire safety subsystem 430. In various embodiments, building subsystems 428 may include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 include waterside system 200 and/or airside system 300, as described with reference to FIGS. 2-3.

Each of building subsystems 428 may include any number of devices, controllers, and connections for completing its individual functions and control activities. HVAC subsystem 440 may include many of the same components as HVAC system 100, as described with reference to FIGS. 1-3. For example, HVAC subsystem 440 may include any number of chillers, heaters, handling units, economizers, field controllers, supervisory controllers, actuators, temperature sensors, and/or other devices for controlling the temperature, humidity, airflow, or other variable conditions within building 10. Lighting subsystem 442 may include any number of light fixtures, ballasts, lighting sensors, dimmers, or other devices configured to controllably adjust the amount of light provided to a building space. Security subsystem 438 may include occupancy sensors, video surveillance cameras, digital video recorders, video processing servers, intrusion detection devices, access control devices and servers, or other security-related devices.

Still referring to FIG. 4, BMS controller 366 is shown to include a communications interface 407 and a BMS interface 409. Interface 407 may facilitate communications between BMS controller 366 and external applications (e.g., monitoring and reporting applications 422, enterprise control applications 426, remote systems and applications 444, applications residing on client devices 448, etc.) for allowing user control, monitoring, and adjustment to BMS controller 366 and/or subsystems 428. Interface 407 may also facilitate communications between BMS controller 366 and client devices 448. BMS interface 409 may facilitate communications between BMS controller 366 and building subsystems 428 (e.g., HVAC, lighting security, lifts, power distribution, business, etc.).

Interfaces 407 and 409 may be or may include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407 and 409 may be direct (e.g., local wired or wireless communications) or via a communications network 446 (e.g., a WAN, the Internet, a cellular network, etc.). For example, interfaces 407 and 409 may include an Ethernet card and port for sending and receiving data via an Ethernet-based communications link or network. In another example, interfaces 407 and 409 may include a Wi-Fi transceiver for communicating via a wireless communications network. In another example, one or both of interfaces 407 and 409 may include cellular or mobile phone communications transceivers. In one embodiment, communications interface 407 is a power line communications interface and BMS interface 409 is an Ethernet interface. In other embodiments, both communications interface 407 and BMS interface 409 are Ethernet interfaces or are the same Ethernet interface.

Still referring to FIG. 4, BMS controller 366 is shown to include a processing circuit 404 including a processor 406 and memory 408. Processing circuit 404 may be communicably connected to BMS interface 409 and/or communications interface 407 such that processing circuit 404 and the various components thereof may send and receive data via interfaces 407 and 409. Processor 406 may be implemented as a general purpose processor, an application specific integrated circuit (ASIC), one or more field programmable gate arrays (FPGAs), a group of processing components, or other suitable electronic processing components.

Memory 408 (e.g., memory, memory unit, storage device, etc.) may include one or more devices (e.g., RAM, ROM, Flash memory, hard disk storage, etc.) for storing data and/or computer code for completing or facilitating the various processes, layers, and modules described in the present application. Memory 408 may be or include volatile memory or non-volatile memory. Memory 408 may include database components, object code components, script components, or any other type of information structure for supporting the various activities and information structures described in the present application. According to an exemplary embodiment, memory 408 is communicably connected to processor 406 via processing circuit 404 and includes computer code for executing (e.g., by processing circuit 404 and/or processor 406) one or more processes described herein.

In some embodiments, BMS controller 366 is implemented within a single computer (e.g., one server, one housing, etc.). In various other embodiments, BMS controller 366 may be distributed across multiple servers or computers (e.g., that may exist in distributed locations). Further, while FIG. 4 shows applications 422 and 426 as existing outside of BMS controller 366, in some embodiments, applications 422 and 426 may be hosted within BMS controller 366 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 may be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 400.

Enterprise integration layer 410 may be configured to serve clients or local applications with information and services to support a variety of enterprise-level applications. For example, enterprise control applications 426 may be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BMS controller 366. In yet other embodiments, enterprise control applications 426 may work with layers 410-420 to optimize building performance (e.g., efficiency, energy use, comfort, or safety) based on inputs received at interface 407 and/or BMS interface 409.

Building subsystem integration layer 420 may be configured to manage communications between BMS controller 366 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translates communications (e.g., sensor data, input signals, output signals, etc.) across a plurality of multi-vendor/multi-protocol systems.

Demand response layer 414 may be configured to optimize resource usage (e.g., electricity use, natural gas use, water use, etc.) and/or the monetary cost of such resource usage in response to satisfy the demand of building 10. The optimization may be based on time-of-use prices, curtailment signals, energy availability, or other data received from utility providers, distributed energy generation systems 424, from energy storage 427 (e.g., hot TES 242, cold TES 244, etc.), or from other sources. Demand response layer 414 may receive inputs from other layers of BMS controller 366 (e.g., building subsystem integration layer 420, integrated control layer 418, etc.). The inputs received from other layers may include environmental or sensor inputs such as temperature, carbon dioxide levels, relative humidity levels, air quality sensor outputs, occupancy sensor outputs, room schedules, and the like. The inputs may also include inputs such as electrical use (e.g., expressed in kWh), thermal load measurements, pricing information, projected pricing, smoothed pricing, curtailment signals from utilities, and the like.

According to an exemplary embodiment, demand response layer 414 includes control logic for responding to the data and signals it receives. These responses may include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models may include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, XML files, etc.). The policy definitions may be edited or adjusted by a user (e.g., via a graphical user interface) so that the control actions initiated in response to demand inputs may be tailored for the user's application, desired comfort level, particular building equipment, or based on other concerns. For example, the demand response policy definitions may specify which equipment may be turned on or off in response to particular demand inputs, how long a system or piece of equipment should be turned off, what setpoints may be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 may be configured to use the data input or output of building subsystem integration layer 420 and/or demand response later 414 to make control decisions. Due to the subsystem integration provided by building subsystem integration layer 420, integrated control layer 418 may integrate control activities of the subsystems 428 such that the subsystems 428 behave as a single integrated supersystem. In an exemplary embodiment, integrated control layer 418 includes control logic that uses inputs and outputs from a plurality of building subsystems to provide greater comfort and energy savings relative to the comfort and energy savings that separate subsystems could provide alone. For example, integrated control layer 418 may be configured to use an input from a first subsystem to make an energy-saving control decision for a second subsystem. Results of these decisions may be communicated back to building subsystem integration layer 420.

Integrated control layer 418 is shown to be logically below demand response layer 414. Integrated control layer 418 may be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 may be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 may be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and AM&V layer 412. Integrated control layer 418 may be configured to provide calculated inputs (e.g., aggregations) to these higher levels based on outputs from more than one building subsystem.

AM&V layer 412 may be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 may be based on building system energy models and/or equipment models for individual BMS devices or subsystems. For example, AM&V layer 412 may compare a model-predicted output with an actual output from building subsystems 428 to determine an accuracy of the model.

FDD layer 416 may be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, or from another data source. FDD layer 416 may automatically diagnose and respond to detected faults. The responses to detected or diagnosed faults may include providing an alert message to a user, a maintenance scheduling system, or a control algorithm configured to attempt to repair the fault or to work-around the fault.

FDD layer 416 may be configured to output a specific identification of the faulty component or cause of the fault (e.g., loose damper linkage) using detailed subsystem inputs available at building subsystem integration layer 420. In other exemplary embodiments, FDD layer 416 is configured to provide “fault” events to integrated control layer 418 which executes control strategies and policies in response to the received fault events. According to an exemplary embodiment, FDD layer 416 (or a policy executed by an integrated control engine or business rules engine) may shut-down systems or direct control activities around faulty devices or systems to reduce energy waste, extend equipment life, or assure proper control response.

FDD layer 416 may be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time-series) data indicating the performance of BMS 400 and the various components thereof. The data generated by building subsystems 428 may include measured or calculated valves that exhibit statistical characteristics and provide information about how the corresponding system or process (e.g., a temperature control process, a flow control process, etc.) is performing in terms of error from its setpoint. These processes may be examined by FDD layer 416 to expose when the system begins to degrade in performance and alert a user to repair the fault before it becomes more severe.

### Actuator and Valve Assembly

Referring generally to the Figures, an actuator is shown, according to an exemplary embodiment. The actuator may be a damper actuator, a valve actuator, a fan actuator, a pump actuator, or any other type of actuator that can be used to actuate a damper, a valve, a mechanical linkage or assembly, or any other type of mechanism or system. The valve may be rotary valves that restrict rotary and linear movement and include mounting faces such as pin, snap-fit, spring clip, groove, spring pin, and other mounting faces. As will be appreciated, an actuator and valve may include different, unengaging or dissimilar mounting faces such that an adaptor is needed to properly interface the actuator and valve.

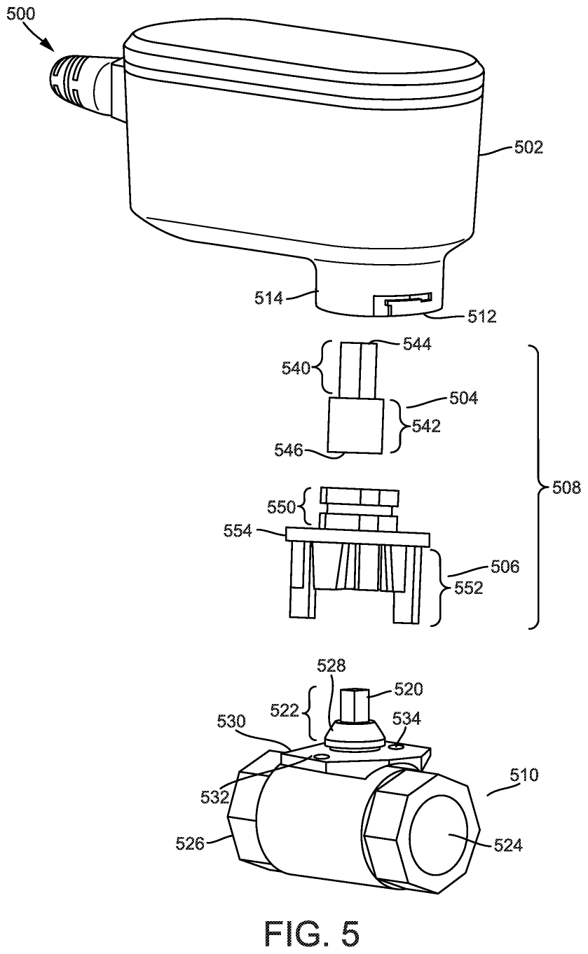

Referring now to FIG. 5, an example implementation of an actuator 502 as part of a valve assembly 500 is shown, according to some embodiments. FIG. 1 is an unassembled exploded perspective view of the valve assembly 500. The valve assembly 500 is shown to include actuator 502 and a valve 510 operably connected by a coupling member 504 and structurally connected by a bracket 506. The coupling member 504 is disposed within the bracket 506 to form the adaptor 508 (e.g., actuator mounting assembly) that allows for the actuator 502 to be operably coupled to the valve 510. The valve 510 regulates the flow of a liquid or gas through it by selectively providing a barrier that impedes the flow of the liquid or gas. The actuator 502 can be operated to control the flow of the liquid or gas through valve 510 by operating the valve stem 520 of valve 510 through the coupling member 504.

The actuator 502 includes an internal cavity 512 disposed within the channel wall 514. The internal cavity 512 includes (e.g., provided within) a driver. The driver includes (or is operably connected to) a connecting member to receive a complementary connecting member from a valve 510 that is compatible with the actuator 502 and/or from the coupling member 504 of the adaptor 508. For example, the connecting member of the actuator 502 defines a “D”-shaped aperture that receives a protrusion that is operably connected to a valve 510 and is configured to be rotated from the unlocked position to the locked position. As explained in greater detail below, the coupling member 504 is configured to provide the protrusion 544 (e.g., protruding member) to engage the aperture and operably connect it with the valve stem 520 to control the valve 510.

In some embodiments, the actuator 502 may be engaged through compressive force. The actuator 502 can be configured to selectively rotate the driver about the central axis 180 of the channel wall 514. As will be appreciated, rotation of the driver will cause the aperture to rotate and will cause the rotation of any member disposed within the aperture (e.g., coupling member 504). Through the adaptor 508 the rotation of the driver of the actuator 502 will cause a valve stem 520 to also rotate, thereby controlling the flow of the liquid or gas through valve 510. In some embodiments, the driver may include a drive mechanism, a hub, or other device configured to drive or effectuate rotational movement of driver. For example, the drive mechanism can control the rotation of the driver by providing force to walls of driver along its principal axis, causing driver to experience a rotational force.

Although actuator 502 is shown as part of valve assembly 500, it should be understood that actuator 502 can be used to actuate a wide variety of equipment. For example, actuator 502 can be used to actuate a damper, a valve, a mechanical linkage or assembly, or any other type of mechanism or system. Actuating the mechanism or system may include driving a moveable component of the mechanism or system between multiple positions, such as driving a valve between an open and closed position. In some embodiments, actuator 502 is used to operate a valve or damper in a HVAC system. In various embodiments, actuator 502 may be a linear actuator (e.g., a linear proportional actuator), a non-linear actuator, a spring return actuator, or a non-spring return actuator.

The valve 510 includes a first end 524, a second end 526, a mounting pad 530 and a valve stem 520 that protrudes away from the mounting pad 530. The valve stem 520 includes a snapping surface 528 adjacent to the mounting pad 530 and a protruding member 522 protruding away from the snapping surface 528. The snapping surface 528 is configured to snap-fit engage a complementary actuator or adaptor. As shown in FIG. 5, the valve stem 520, specifically the snapping surface 528, is incompatible for mounting by the actuator 502, as the actuator 502 lacks a snap-fit feature on or in the channel wall 512. The valve stem 520 can be attached to valve 510 such that rotation of valve stem 520 about its principal axis regulates the opening and closing of the first end 524 and/or second end 526 of the valve 510. For example, if valve 510 is a ball valve, valve stem 520 may be coupled to a ball internal to valve 510 having a port hole extending through the ball. As valve stem 520 is rotated about its principal axis, the ball is also rotated. When valve 510 is fully open, it allows the flow of a liquid or gas through valve openings on the first end 524 and/or second end 526. When valve 510 is fully closed, it prevents the flow of a liquid or gas through valve openings on the first end 524 and/or second end 526. While the valve 510 in FIG. 5 is a two-way valve, in other embodiments, the valve 510 may be a T-shaped three-way ball valve with two aligned ports and a perpendicular port.

The valve 510 includes mounting pad 530 that, along with the snapping surface 528 of the valve stem 520, interlocks with a complementary structure (e.g., actuator or the adaptor 508). The mounting pad 530 includes a surface for support of the structure that snap-fits with the snapping surface 528 and include a first mounting opening 532 formed in the mounting pad 530 and a second mounting opening 534 formed in the mounting pad 530. The first mounting opening 532 and the second mounting opening 534 are disposed on opposite sides of the mounting pad 530 and are configured to receive a complementary protrusion that is press-fit into the holes. As will be appreciated, the mounting pad 530, through the mounting holes and pad, and the snapping surface 528 provides support for the linkage system (e.g., complementary actuator or adaptor 508) when the valve assembly 500 is assembled.

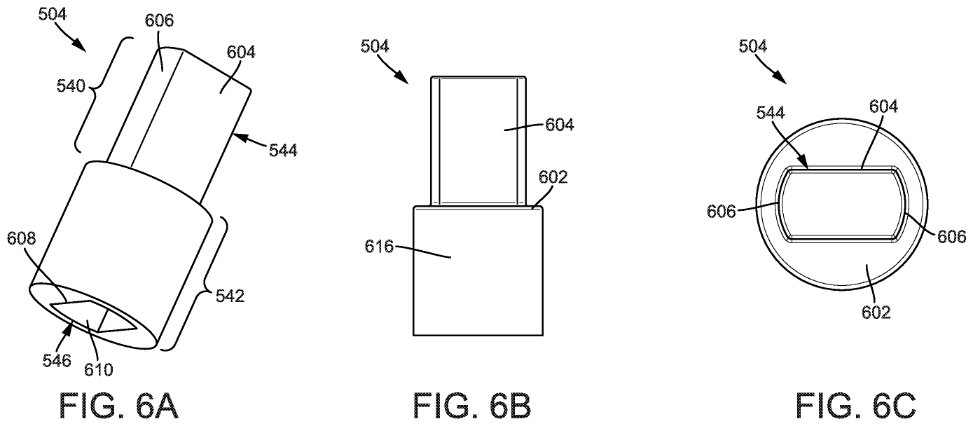

The adaptor 508 is configured to interface the actuator 502 and the valve 510, as the actuator 502 and the valve 510 do not have complementary engagement surfaces. Accordingly, an adaptor 508 is required to properly engage the actuator 502 and valve 510 and to operably connect the driver of the actuator 502 with the protruding member 522 of the valve stem 520. The adaptor 508 includes a coupling member 504 that is disposed within and able to rotate within a bracket 506. The coupling member 504 includes a driver end 540 and a valve stem end 542 that are configured to operably connect the driver of the actuator 502 with the protruding member 522 of the valve stem 520. The driver end 540 includes a protrusion 544 that is shaped to be inserted into and engage the aperture of the actuator 502. The valve stem end 542 includes a groove 546 that is shaped to receive the protruding member 522 of the valve stem 520. In other words, the coupling member 504 interfaces the driver and the valve stem 520 such that the rotation of the driver and aperture cause the coupling member 504 to rotate, which in turn causes the valve stem 520 to rotate. The coupling member 504 is described in greater detail below in FIGS. 6A-6C.

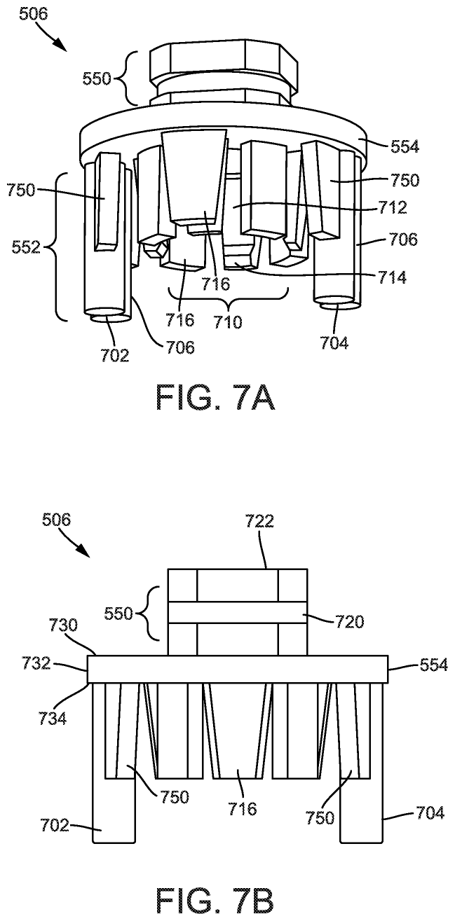

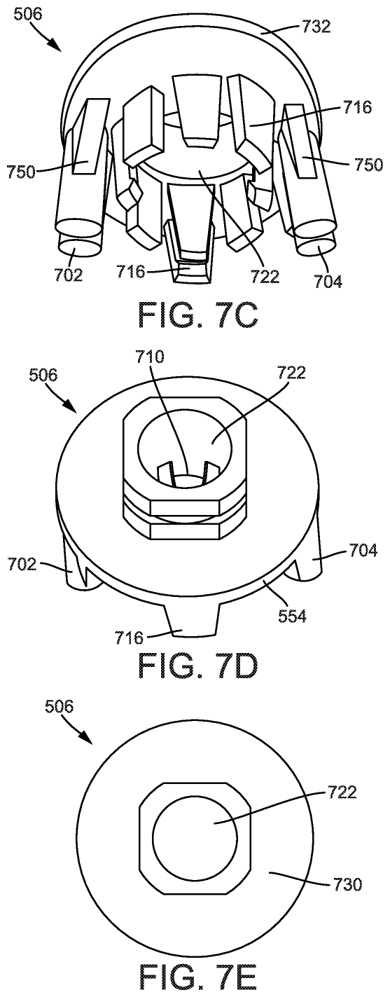

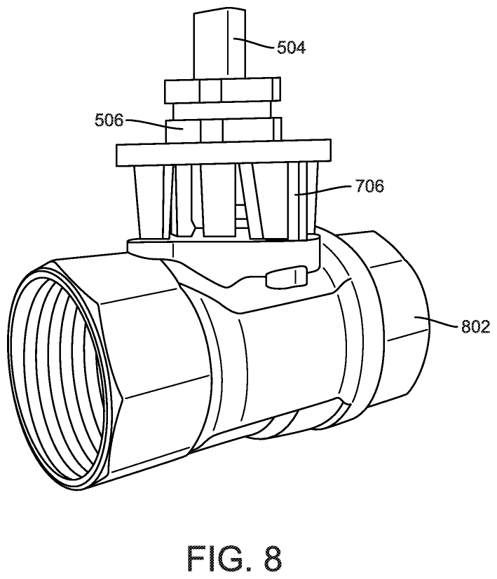

The bracket 506 is configured to couple the actuator 502 to the valve 510 and allow for the coupling member 504 to move (e.g., rotate) within the bracket 506 to operably engage the driver and the valve stem 520. The bracket 506 includes an actuator end 550, a middle portion 554, and valve end 552. Generally, the actuator end 550 is configured to engage the internal cavity 512 of the channel wall 514 to “lock” the actuator 502 with the bracket 506. While the actuator end 550 is shown having a square-like protrusion with a channel to be inserted into the internal cavity 512 and rotated from an unlocked position to a locked position, a wide variety of shapes with a wide variety of sizes may be implemented on the actuator end 550 to interface and lock with an actuator 502. The middle portion 554 is disposed between the actuator end 550 and the valve end 552 and is configured to provide support to each end of the bracket 506 and provide a resting surface for the actuator 502 and/or the valve 510. The valve end 552 is configured to engage the valve stem 520 and/or mounting pad 530 of the valve 510. While the valve end 552 is shown having a plurality of legs (e.g., arms) that snap-fit with the snapping surface 528 of the valve stem 520, a wide variety of shapes with a wide variety of sizes may be implemented on the valve end 552 to interface and lock with the valve 510. The bracket 506 is described in greater detail below in FIGS. 7A-7E.

Referring to FIGS. 6A-6C, views of the coupling member 504 are shown, according to an example embodiment. The coupling member 504 is configured to interface the driver of the actuator 502 and the valve stem 520 of the valve 510 (specifically the protruding member 522 of the valve stem 520), such that the rotation of the driver causes the coupling member 504 to rotate, which in turn causes the valve stem 520 to rotate. The coupling member 504 includes the driver end 540, a middle surface 602, and the valve stem end 542. The driver end 540 and the valve stem end 542 are configured to operably connect the driver of the actuator 502 with the valve stem 520 of the valve 510, respectively. The driver end 540 includes the protrusion 544 that extends away from the middle surface. The protrusion 544 is shaped to be inserted into and engage the aperture of the actuator 502. As shown in FIG. 6C, the protrusion 544 is a “D”-shaped structure with two substantially parallel surfaces 604 that are parallel to each other and two rounded surfaces 606 that are mirror images to each other. As will be appreciated, the shape of the protrusion 544 can be altered to engage a wide variety actuators.

The valve stem end 542 is configured to have a diameter and size that allows it to be disposed within and able to rotate within a coupling opening 722 formed in the bracket 506. The valve stem end 542 includes a groove 546 that is shaped to receive the valve stem 520 of the valve 510. The coupling member 504 interfaces the driver and the valve stem 520 such that the rotation of the driver and aperture cause the coupling member 504 to rotate, which in turn causes the valve stem 520 to rotate. As shown in FIG. 6A, the groove 546 is a “D”-shaped structure with two substantially parallel surfaces 608 that are parallel to each other and two rounded surfaces 610 that mirror each other. The groove 546 is disposed within a substantially cylindrical structure 616. As will be appreciated, the shape of the groove 546 can be altered to receive a valve stem of a wide variety of valves. As shown in FIG. 6A, the shape of the groove 546 may be identical to the shape of the protrusion 544, with the groove 546 being rotated 90-degrees relative to the orientation of the protrusion 544.

Referring to FIGS. 7A-7E, views of the bracket 506 are shown, according to an example embodiment. The bracket 506 is configured to rotationally engage the actuator 502 and snap-fit and/or press-fit the valve 510. Generally, the actuator end 550 engages the internal cavity 512 of the channel wall 514 to “lock” the actuator 502 with the bracket 506. The bracket 506 may include a feature that is designed to interface with the actuator 502 in a particular orientation to ensure that the actuator 502 is positioned in a specific orientation relative to the valve 510. The valve end 552 includes a plurality of legs, with some of the plurality of legs rigid to engage the mounting pad 530 and some of the plurality of legs flexible and configured to engage the snapping surface 528. The bracket 506 may include a feature that is designed to interface with the valve 510 in a particular orientation to ensure that the valve 510 is positioned in a specific orientation relative to the actuator 502. As shown in FIGS. 7A-7E, the elongated legs 702, 704 of the valve end 552 ensure that the bracket 506 has two possible orientations when engaging the valve 510 (e.g., a first orientation and a second orientation that is rotated 180 degrees from the first orientation). Additionally, the bracket 506 is configured to receive and house the coupling member 504 without restricting the movement (e.g., rotational, linear, etc.) of the coupling member 504 caused by the driver of the actuator 502 and translated to the valve stem 520.

The actuator end 550 of the bracket 506 includes a slot 720 and a coupling opening 722 that is centrally disposed and extend through the actuator end 550. The actuator end 550 is shown as having a specific height and a body that is substantially square with angled edges, both configured to engage a complementary shape in the actuator 502. A slot 720 extends around the perimeter of the actuator end 550 and is located substantially central along the axial length of the actuator end 550. The slot 720 is configured to receive a locking feature of the actuator 502 to lock the bracket 506 and the actuator 502. Coupling opening 722 extends through the bracket 506 and is configured to receive the coupling member 504.

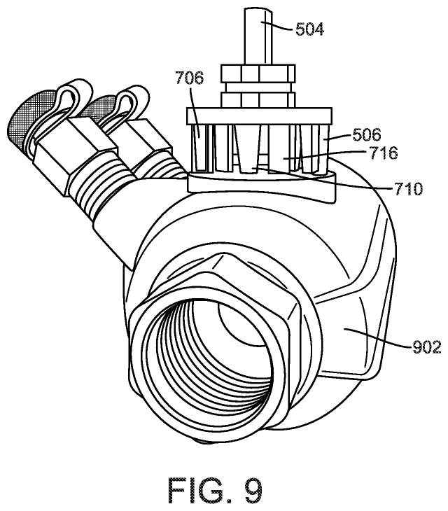

As will be appreciated, the height and width of the driver end 540 of the coupling member 504 may be altered to allow for the more or less of the driver end 540 to be disposed within the coupling opening 722. As shown in in FIGS. 8 and 9, the driver end 540 is substantially outside of the coupling opening 722. The diameter (or width) of the valve stem end 542 of the coupling member 504 is substantially similar to the diameter of the coupling opening 722 to ensure a snug fit of the valve stem end 542 that does not restrict the rotational movement (or linear in alternative valve 510 and actuator 502 configurations) of the valve stem end 542.

The middle portion 554 is disposed between the actuator end 550 and the valve end 552 of the bracket 506. The middle portion 554 includes a first end 730, a second end 734, and a central surface 732 disposed between the first end 730 and the second end 734. The actuator end 550 protrudes from the first end 730 in a direction away from the second end 734. The plurality of legs on the valve end 552 protrude from the second end 734 in a direction away from the first end 730.

A plurality of legs (e.g., rigid and/or flexible legs) extend from the second end 734 of the middle portion 554 to engage a valve 510. The plurality of legs includes: a first elongated leg 702 and a second elongated leg 704 disposed outermost and adjacent to an edge of the perimeter of the second end 734; a plurality of support legs 716 that are disposed between the first elongated leg 702 and the second elongated leg 704 and a plurality of snap-fit legs 710; the plurality of snap-fit legs 710 that are innermost and are disposed between the plurality of support legs 716 and the coupling opening 722.

The first elongated leg 702 and the second elongated leg 704 are disposed on opposite ends of the second end 734 and are configured to be inserted into the first mounting opening 532 and the second mounting opening 534, respectively. The first elongated leg 702 and the second elongated leg 704 include a groove 706 that runs axially along both ends of the first elongated leg 702 and the second elongated leg 704 to provide additional support and engagement with the first mounting opening 532 and the second mounting opening 534. In some embodiments, the groove 706 is configured to provide flexibility within each of the first elongated leg 702 and the second elongated leg 704 such that each leg can be compressed radially inward during insertion into the mounting holes 532, 534. In other words, the first elongated leg 702 and the second elongated leg 704 provide a squeeze and snap-fit into the mounting holes 532, 534 to provide further engagement of the bracket 506 and the valve 510.

The first elongated leg 702 and the second elongated leg 704 may include an angled support portion 750 on one or both sides of the first elongated leg 702 and the second elongated leg 704. The angles support portion 750 may facilitate installation of the bracket 506 with the valve 510 and support the bracket 506 and the actuator 502 on the valve 510. The first elongated leg 702 and the second elongated leg 704 act as the positioning element/poke yoke feature for the bracket 506 to ensure that the actuator 502 has a specific, desired orientation. As shown in FIGS. 7A-7E, the first elongated leg 702 and the second elongated leg 704 extend axially longer than the other legs, as needed to properly be inserted into the first mounting opening 532 and the second mounting opening 534. As will be appreciated, the first elongated leg 702 and the second elongated leg 704 may have a wide variety of shapes and sizes and may be included in a variety of locations to properly engage the valve 510. In some embodiments, the first elongated leg 702 includes two separate protruding members and a gap defined at the location of the groove 706.

The plurality of support legs 716 protrude from the second end 734 and are disposed at the same radius and/or outside of the plurality of snap-fit legs 710. Some legs in the plurality of support legs are axial protrusion that have the same disposition along the radius of one or more of the plurality of snap-fit legs 710.

While FIGS. 7A-7E show three support legs in the plurality of support legs 716, one or more support legs may make up the plurality of support legs 716 to provide additional support to the engagement of the actuator 502, adaptor 508, and the valve 510. Each support leg in the plurality of support legs 716 may be a rigid leg that are dispersed along the second end 734 to provide support for the weight of the actuator 502 that is coupled on the actuator end 550 of the bracket 506. The plurality of support legs 716, the first elongated leg 702, and the second elongated leg 704 restrict rotary motion of the actuator 502.

The plurality of snap-fit legs 710 protrude from the second end 734 and are disposed inside of the plurality of support legs 716 and outside (e.g., around) the coupling opening 722. The plurality of snap-fit legs 710 are positioned and configured to engage the snapping surface 528 of the valve stem 520. While FIGS. 7A-7E show side snap-fit legs in the plurality of snap-fit legs 710, one or more snap-fit legs may make up the plurality of snap-fit legs 710 to provide additional engagement of the adaptor 508 and the valve 510. As will be appreciated, the snap-fit legs 710 may be configured to engage a wide variety of engagement surfaces (e.g., snapping surface 528). Each snap-fit leg in the plurality of snap-fit legs 710 is a radially flexible leg that is orientated in relation to the first elongated leg 702 and the second elongated leg 704 to engage the centrally located snapping surface 528. In some embodiments, one or more snap-fit legs in the plurality of snap-fit legs 710 are rigid, axial protrusions that are substantially flat and come in contact with the mounting pad of the valve 510.

Each snap-fit leg in the plurality of snap-fit legs 710 includes an axial rib portion 712 that is radially flexible and a snap feature 714 disposed on the tip of the rib portion 712. As the bracket 506 is moved axially downward to engage the valve stem 520, the axial rib portions 712 come in contact with the top portion of the snapping surface 528 and flexes radially outward until the snap feature 714 engages the snapping surface 528 and flexes radially inward to snap-fit the bracket 506 and the valve 510. As is readily apparent, the hooked structure of the snap feature 714 securely engages the valve stem 520 at the snapping surface 528. The plurality of snap-fit legs 710 enhances proper assembly of the actuator 502 and the valve 510 and restricts linear motion of the actuator 502.

Referring to FIG. 8, a valve 802 with the snap-fit bracket 508 is shown. As shown in FIG. 8, the fit adaptor 508 has the first elongated leg 702 engaging a mounting hole in the valve 802. As shown in FIG. 8, the protrusion 544 of the coupling member 504 is disposed outside of the bracket 506 to engage an aperture in an actuator. Turning to FIG. 9, a valve 902 with the fit adaptor 508 is shown. As shown in FIG. 9, the snap-fit adaptor 508 has the first elongated leg 702 engaging a mounting hole in the valve 9. As shown in FIG. 9, the protrusion 544 is disposed outside of the bracket 506 to engage an aperture in an actuator.

### Configuration of Exemplary Embodiments

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the HVAC actuator and assembly thereof as shown in the various exemplary embodiments is illustrative only. Additionally, any element disclosed in one embodiment may be incorporated or utilized with any other embodiment disclosed herein. Although only a few embodiments have been described in detail in this disclosure, many modifications are possible (e.g., variations in sizes, dimensions, structures, shapes and proportions of the various elements, valves of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

What is claimed is:

1. An actuator mounting assembly, comprising:
a bracket defining a central opening extending therethrough, the bracket comprising a middle portion, an actuator end, and a valve end,
the middle portion disposed between the actuator end and the valve end;
the actuator end comprising an actuator interface member,
the valve end comprising a plurality of legs extending from the middle portion away from the actuator end; and
a coupling member at least partially disposed within the central opening, the coupling member comprising a valve stem end configured to engage a valve stem and a driver end configured to engage an actuator drive member.

2. The actuator mounting assembly of claim 1, wherein the plurality of legs comprises:
a first leg and a second leg disposed outermost and adjacent to an edge of the middle portion, the first leg and the second leg each configured to engage a mounting hole formed by a valve body; and
a plurality of snap-fit legs disposed inside of the first leg and the second and outside the central opening, the plurality of snap-fit legs configured to engage the valve body in a snap-fit engagement.

3. The actuator mounting assembly of claim 2, wherein each snap-fit leg of the plurality of snap-fit legs comprises a radially flexible leg and a snap member to engage a portion of the valve body.

4. The actuator mounting assembly of claim 3, wherein the snap member is a hooked member that protrudes radially inward toward the central opening, the hooked member configured to securely engage a snap surface on the valve stem.

5. The actuator mounting assembly of claim 2, wherein the mounting hole comprises a first mounting hole and a second mounting hole, wherein the first leg and the second leg are disposed on opposite ends of the middle portion, the first leg comprising a first groove that is formed axially therealong and the second leg comprising a second groove that is formed axially therealong, the first groove and the second groove configured to orient the bracket in a desired orientation when the first leg is disposed within the first mounting hole and the second leg is disposed within the second mounting hole.

6. The actuator mounting assembly of claim 2, further comprising a plurality of support legs disposed between the first leg and the second leg, the plurality of support legs configured to engage a mounting pad on the valve body and to restrict rotary motion of an actuator that includes the actuator drive member.

7. The actuator mounting assembly of claim 1, wherein actuator interface member axially protrudes from the middle portion away from the valve end, the actuator interface member comprising a slot and the central opening extending therethrough, the slot extend around an external surface of the actuator interface member, the slot configured to receive a locking surface of an actuator that comprises the actuator drive member.

8. The actuator mounting assembly of claim 1, wherein the valve stem end is disposed substantially within the central opening of the bracket, and wherein the driver end is disposed substantially outside of the central opening of the bracket.

9. The actuator mounting assembly of claim 1, wherein the valve stem end comprises a coupling groove configured to receive the valve stem and the driver end include a coupling protruding member configured to be inserted into the actuator drive member.

10. The actuator mounting assembly of claim 9, wherein the coupling groove comprises a groove that is formed by two mirrored parallel surfaces and two mirrored rounded surfaces, wherein the protruding member comprises a protrusion being formed by similar mirrored parallel surfaces and two mirrored rounded surfaces.

11. The actuator mounting assembly of claim 1, wherein rotation of the actuator drive member causes the driver end to rotate and the valve stem end to rotate, thereby rotating the valve stem.

12. A valve assembly comprising:
an actuator comprising an actuator drive member, the actuator drive member;
a valve body comprising a valve stem; and
an actuator mounting assembly, comprising:
a bracket defining a central opening extending therethrough, the bracket comprising an actuator end and a valve end,
the actuator end comprising an actuator interface member,
the valve end comprising a plurality of legs extending away from the actuator end; and
a coupling member at least partially disposed within the central opening, the coupling member comprising a valve stem end configured to engage a valve stem and a driver end configured to engage the actuator drive member.

13. The valve assembly of claim 12, wherein the valve body comprises a first mounting hole and a second mounting hole formed by a valve body, and wherein the plurality of legs comprises:
a first leg and a second leg disposed outermost and adjacent to an edge of the middle portion, the first leg configured to engage the first mounting hole formed by the valve body, and the second leg configured to engage the second mounting hole formed by the valve body; and
a plurality of snap-fit legs disposed inside of the first leg and the second leg and outside the central opening, the plurality of snap-fit legs configured to engage the valve body in a snap-fit engagement.

14. The valve assembly of claim 13, wherein each snap-fit leg of the plurality of snap-fit legs comprises a radially flexible leg and a snap member to engage a portion of the valve body, the snap member is a hooked member that protrudes radially inward toward the central opening, the hooked member configured to securely engage a snap surface on the valve stem.

15. The valve assembly of claim 13, wherein the first leg and the second leg are disposed on opposite ends of the middle portion, the first leg comprising a first groove that is formed axially therealong and the second leg comprising a second groove that is formed axially therealong, the first groove and the second groove configured to orient the bracket in a desired orientation when the first leg is disposed within the first mounting hole and the second leg is disposed within the second mounting hole.

16. The valve assembly of claim 13, wherein the valve body further comprises a mounting pad surrounding the valve stem, and wherein the plurality of legs further comprises a plurality of support legs disposed between the first leg and the second leg, the plurality of support legs configured to engage a mounting pad on the valve body and to restrict rotary motion of the actuator.

17. The valve assembly of claim 12, wherein actuator interface member axially protrudes from the middle portion away from the valve end, the actuator interface member comprising a slot and the central opening extending therethrough, the slot extend around an external surface of the actuator interface member, the slot configured to receive a locking surface of the actuator.

18. The valve assembly of claim 12, wherein the valve stem end comprises a coupling groove configured to receive the valve stem and the driver end include a coupling protruding member configured to be inserted into the actuator drive member, and wherein the valve stem end is disposed substantially within the central opening of the bracket, and wherein the driver end is disposed substantially outside of the central opening of the bracket.

19. A method of assembling a valve assembly, the method comprising:
inserting a coupling member within a central opening of a bracket to form an actuator mounting assembly,
the bracket defining a central opening therethrough and the bracket comprising an actuator end and a valve end, the actuator end comprising an actuator interface member and the valve end comprising a plurality of legs extending away from the actuator end,
the coupling member comprising a valve stem end configured to engage a valve stem and a driver end configured to engage an actuator drive member, the coupling member inserted within the bracket such that the valve stem end is at least partially disposed within the central opening and the driver end is at least partially disposed outside of the central opening;
engaging the actuator mounting assembly with a valve body, the engagement including inserting a valve stem of the valve body into a groove formed in the valve stem end and coupling the plurality of legs with the valve body; and
engaging the actuator end of the bracket with an actuator, the engagement causing the driver end of the coupling member to be inserted within the actuator drive member of the actuator.

20. The method of claim 19, wherein the plurality of legs comprises:
a first leg and a second leg disposed outermost and adjacent to an edge of the valve end, the first leg configured to engage a first mounting hole formed by a valve body and the second leg configured to engage a second mounting hole formed by a valve body; and
a plurality of snap-fit legs disposed inside of the plurality of support legs and outside the central opening, wherein each snap-fit leg of the plurality of snap-fit legs comprises a radially flexible leg and a snap member to engage a portion of the valve body, the snap member protrudes radially inward toward the central opening; and
wherein engaging the actuator mounting assembly with the valve body further comprises:
inserting the first leg into the first mounting hole and the second leg into the second mounting hole; and
pressing the actuator mounting assembly downward to cause the snap member of each snap-fit leg in the plurality of snap-fit legs to securely engage a snap surface on the valve stem.
